(19) United States
(12) Patent Application Publication
(10) Pub. No.: US 2023/0398799 A1
(43) Pub. Date: Dec. 14, 2023

(54) RIBBON SUPPLY ROLL HAVING ZONE-COATED SPLICE TAPE

(71) Applicant: Entrust Corporation, Shakopee, MN (US)

(72) Inventor: Gene Meier, Shakopee, MN (US)

(21) Appl. No.: 18/332,374

(22) Filed: Jun. 9, 2023

Related U.S. Application Data
(60) Provisional application No. 63/366,376, filed on Jun. 14, 2022.

(51) Int. Cl. B41J 32/00; B65H 75/10; C09J 7/38; B41J 3/28

(52) U.S. Cl. CPC B41J 32/00; B65H 75/10; C09J 7/38; B41J 3/28; B65H 2701/194; C09J 2301/302

(57) ABSTRACT

A ribbon supply roll for use in a plastic card or passport personalization machine. The ribbon supply roll includes a zone-coated splice tape with a pressure sensitive adhesive on a backing film where the adhesive does not flow or ooze beyond the edges of the backing film. Therefore, a transferrable material on a winding layer in contact with the splice tape is not pulled away. For example, portions of the backing film of the splice tape are not coated with the adhesive which permits the adhesive to flow or ooze when pressure is applied to the splice tape. However, the adhesive does not flow enough to flow beyond the edges of the backing film.

### FIELD

This technical disclosure relates to ribbon supplies that are used in plastic card and passport personalization machines such as desktop personalization machines and central issuance machines.

### BACKGROUND

In ribbon supplies used in plastic card and passport personalization machines, it is sometimes necessary to splice the ends of two films together using splice tape. For example, FIGS. 1A and 1B illustrate the use of conventional splice tape 10 on a print ribbon. FIGS. 1A-B illustrate two consecutive winding layers 12a, 12b of a supply roll of the print ribbon with the winding layer 12b being positioned radially outward of and wound around the winding layer 12a. The winding layer 12a includes a first section of ribbon 14 that is interconnected to a second section of ribbon 16 by the splice tape 10 at the joint 18. The winding layer 12b is a continuation of the first section of ribbon 14 that is wound around the winding layer 12a, with numerous additional winding layers (not illustrated) corresponding to the first section of ribbon 14 wound over the winding layer 12b to form the print ribbon supply roll. In this example, the first section of ribbon 14 is depicted as including a carrier film 20 and a transferrable ink/dye material 22, such as separate color ink/dye panels, disposed on the carrier film 20 for applying coloring to a plastic card or a passport. The second section of ribbon 16 is depicted as being a trailer without any transferrable material thereon and that is used to initiate winding of the print ribbon onto a core (not shown).

The splice tape 10 includes a backing film 24 and a pressure sensitive adhesive (PSA) 26 on the backing film 24. The PSA 26 contacts both the first section of ribbon 14 and the second section of ribbon 16 and bridges the joint 18 thereby interconnecting the two sections 14, 16. When the winding layer 12b and the subsequent winding layers are wound over the splice tape 10, pressure is applied to the splice tape 10 which causes the PSA 26 to flow or ooze beyond the edges of the backing film 24. This flowing of the PSA 26 beyond the edges is indicated at 26a, 26b. The adhesive 26a, 26b bonds with corresponding portions of the transferrable ink/dye material 22 on the winding layer 12b. When it comes time to use that section of the winding layer 12b and that section of the winding layer 12b is unwound from the splice tape 10, portions of the transferrable ink/dye material 22 adhere to the adhesive 26a, 26b and are peeled off the winding layer leaving voids 28a, 28b in the transferrable ink/dye material 22. Therefore, voids may be formed in a printed image when the transferrable ink-dye material 22 containing the voids is used to print the printed image on the plastic card or passport.

### SUMMARY

A ribbon supply roll is described herein for use in a plastic card or passport personalization machine. The ribbon supply roll includes a zone-coated splice tape where the PSA on the backing film of the splice tape is configured so that the PSA does not flow or ooze beyond the edges of the backing film. Therefore, a transferrable material on a winding layer in contact with the splice tape is not pulled away. For example, portions of the backing film of the splice tape are not coated with the PSA. This permits the PSA to flow or ooze when pressure is applied to the splice tape. However, the PSA does not flow enough to flow beyond the edges of the backing film.

A plastic card and a passport may be generally referred to as a personalized identification document. Examples of plastic cards include, but are not limited to, financial (e.g., credit, debit, or the like) cards, access cards, driver's licenses, national identification cards, and business identification cards. In an embodiment, the plastic card may be an ID-1 card as defined by ISO/IEC 7810. However, other card formats such as ID-2 as defined by ISO/IEC 7810 are possible as well. In an embodiment, the passport may be in an ID-3 format as defined by ISO/IEC 7810.

In one embodiment described herein, a ribbon supply roll for use in a plastic card or passport personalization machine is described. The ribbon supply roll includes a core and a ribbon wound on the core, where at least a portion of the ribbon includes a carrier film and a transferrable material disposed on the carrier film. The transferrable material is suitable for being transferred from the carrier film to a plastic card or a passport in the plastic card or passport personalization machine. A splice tape is disposed along a length of the ribbon and interconnects two initially separate sections of the ribbon. The splice tape includes a backing film and a pressure sensitive adhesive on the backing film, and the pressure sensitive adhesive does not extend beyond edges of the backing film.

In another embodiment described herein, a method of forming a ribbon supply roll of a plastic card or passport personalization machine is described. The method includes interconnecting a first section of ribbon and a second section of ribbon using splice tape, where at least one of the first section of ribbon and the second section of ribbon includes a carrier film and a transferrable material disposed on the carrier film, wherein the transferrable material is suitable for being transferred from the carrier film to a plastic card or a passport in the plastic card or passport personalization machine. The splice tape includes a backing film and a pressure sensitive adhesive on the backing film, and there is a gap between the pressure sensitive adhesive and edges of the backing film. The interconnected first section of ribbon and second section of ribbon are then wound onto a core.

A splice tape configured for use in interconnecting a first section of ribbon and a second section of ribbon of a ribbon supply roll of a plastic card or passport personalization machine is also provided. The splice tape can include a backing film, and a pressure sensitive adhesive on the backing film with gaps between end edges of the pressure sensitive adhesive and end edges of the backing film. Optionally, gaps may also be provided between side edges of the pressure sensitive adhesive and side edges of the backing film.

### DRAWINGS

FIGS. 1A and 1B illustrate an example of a conventional splice tape used to splice two sections of ribbon to one another to form a print ribbon.

FIG. 2 illustrates a ribbon supply roll that includes the new splice tape described herein.

FIG. 3 illustrates an example of a personalized identification document in the form of a plastic card.

FIG. 4 illustrates another example of a personalized identification document in the form of a passport.

FIG. 5 schematically depicts an example arrangement of components of an identification document processing system that can use a ribbon supply roll described herein.

FIG. 6 schematically depicts another example arrangement of components of an identification document processing system that can use a ribbon supply roll described herein.

FIG. 7 is a top view of the new splice tape described herein relative to first and second sections of ribbon to be interconnected by the new splice tape.

FIG. 8 is a cross-sectional view taken along line 8-8 of FIG. 7.

FIG. 9 illustrates two consecutive winding layers of the ribbon supply roll of FIG. 2 including the new splice tape.

FIG. 10 is a view similar to FIG. 9 but with the winding layer unwound from the new splice tape.

FIG. 11 illustrates another example of the new splice tape interconnecting first and second sections of ribbon.

FIG. 12 illustrates another example of the new splice tape interconnecting first and second sections of ribbon.

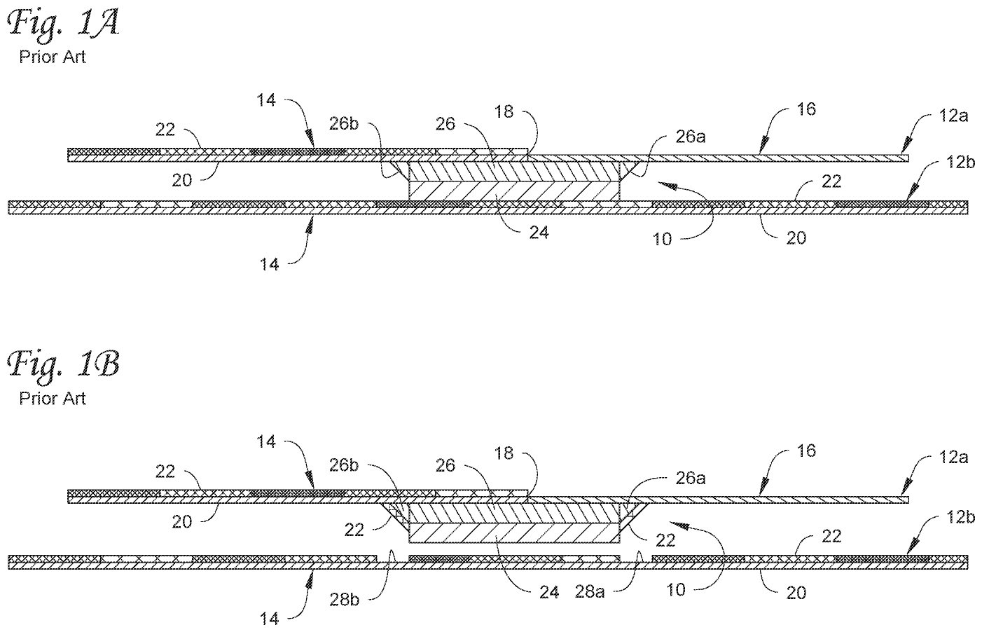

### DETAILED DESCRIPTION

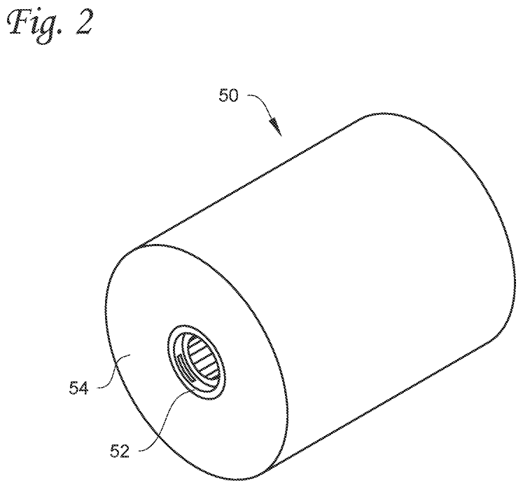

FIG. 2 illustrates an example of a ribbon supply roll 50 that includes the new splice tape (not depicted in FIG. 2) described herein. The ribbon supply roll 50 includes a core 52 and a ribbon 54 wound onto the core 52 in a number of windings or winding layers. The ribbon supply roll 50 may also be referred to as a ribbon supply.

The ribbon supply roll 50 can be mounted directly into a plastic card or passport personalization machine in which the ribbon supply roll 50 is to be used. In another embodiment, the ribbon supply roll 50 is intended to be removably mounted onto a re-usable cartridge that is removably installable into the plastic card or passport personalization machine, where the cartridge can be removed from the machine, the ribbon supply roll removed and replace with a new ribbon supply roll, and the cartridge reinstalled into the plastic card or passport personalization machine. In another embodiment, the ribbon supply roll 50 is intended to be mounted in a disposable cartridge that is removably installable into the plastic card or passport personalization machine and that is thrown away when the ribbon supply roll 50 is used up.

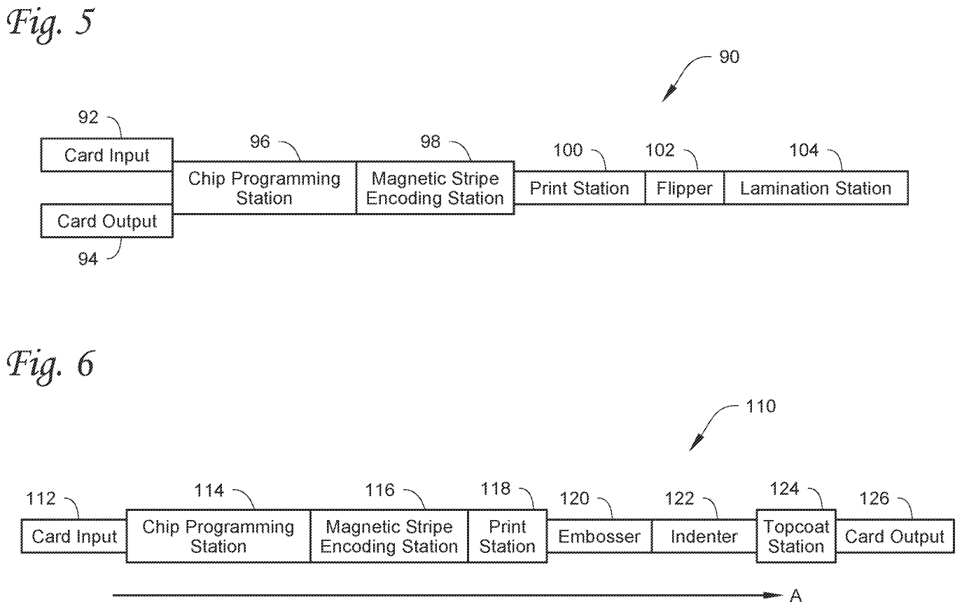

The ribbon supply roll 50 can include any type of consumable ribbon 54 that is used in a plastic card or passport personalization machine and that from time-to-time needs to be replaced with a new ribbon supply roll. In one embodiment, the ribbon supply roll 50 is intended for use in a plastic card personalization machine that is designed to personalize one or more plastic cards including, but not limited to financial (e.g., credit, debit, or the like) cards, driver's licenses, national identification cards, business identification cards, gift cards, and other plastic cards which bear personalized data unique to the cardholder and/or which bear other card information. In some embodiments, the ribbon supply roll may be intended to be used in a passport personalization machine that is designed to personalize passports or other non-card-like documents (which machine can generally be referred to as a card personalization machine). The plastic card personalization machine can be a desktop card personalization machine (see FIG. 5) that is designed to personalize cards/passports one at a time, on the order of tens per hour, or a central issuance machine (see FIG. 6) that is designed to simultaneously personalize multiple cards/passport, on the order of hundreds or thousands per hour. For sake of convenience, the machine with which the ribbon supply roll 50 is used may be described as being a plastic card personalization machine that is intended to encompass a machine that personalizes cards as well as passports and other identification documents.

The ribbon 54 can be any ribbon that includes a carrier film and a transferrable material disposed on the carrier film, that is used in a plastic card or passport personalization machine, and that from time-to-time needs replacement. Examples of ribbons 54 include, but are not limited to, print ribbons, retransfer films, laminate ribbons, topcoat ribbons, holographic films, embossed character tipping/topping foils, indent foils, and other consumable supplies that have a carrier film and a transferrable material on the carrier film. The general construction of print ribbons, retransfer films, laminate ribbons, topcoat ribbons, holographic films, embossed character tipping/topping foils, indent foils, and other consumable supplies that have a carrier film and a transferrable material on the carrier film used in plastic card or passport personalization machines is well known in the art. As used herein, a ribbon, a foil, and a film are intended to refer to similar structures. In the case of a print ribbon, the print ribbon can be a monochromatic (i.e. single color) ribbon or a ribbon with multiple discrete color panels, for example a YMCK print ribbon containing yellow, magenta, cyan and black panels, a YMCKT print ribbon, a YMCKT-KT print ribbon, or the like. The material that is transferrable from the ribbon 54 can be any material or combinations of materials that is transferrable from a ribbon onto a plastic card or a passport in a plastic card or passport personalization machine including, but not limited to, ink, dye, topcoat material, overlay material, print receptive material of a retransfer ribbon, a clear/transparent laminate, a holographic patch, and other materials.

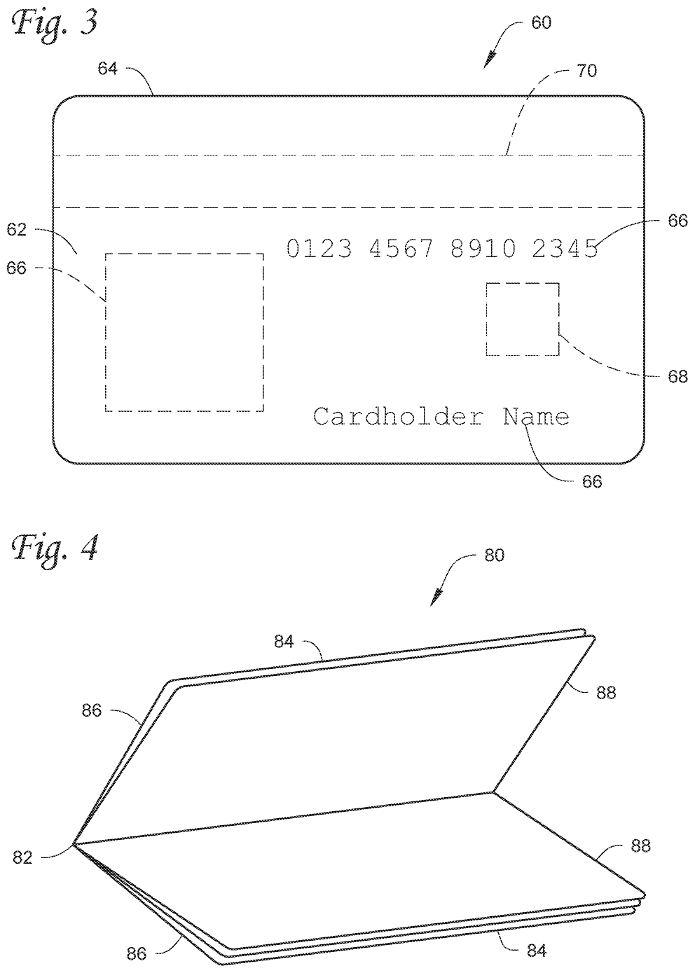

FIG. 3 illustrates an example of a plastic card 60 that can be personalized using the ribbon supply roll 50. The term “plastic card” as used throughout the specification and claims, unless indicated otherwise, refers to a card where the card substrate can be formed entirely of plastic, or formed of a combination of plastic and non-plastic material. The card 60 may also be partially or entirely formed of biodegradable materials whereby the card 60 may be partially biodegradable or entirely biodegradable. In this example, the card 60 is shown to include a front surface 62, a rear or back surface (not visible) opposite the front surface 62, and a perimeter edge 64 that defines the perimeter of the card 60. The card 60 includes various personal data 66, an optional integrated circuit chip 68, and an optional magnetic stripe 70 that is located on the card, for example on the rear surface. With continued reference to FIG. 3, the personal data 66 in this example can be a photograph of the intended card holder, a personal account number, a CVV number, and the name of the cardholder. Some or all of the personal data 66 may be printed on the card 60 for example using retransfer printing or direct to card thermal printing.

FIG. 4 illustrates an example of a passport 80 (also referred to as a passport booklet) that can be personalized using the ribbon supply roll 50. The passport 80 includes a plurality of sheets including a front cover, a back cover, and a plurality of intermediate sheets between the front cover and the back cover. The sheets are bound, for example by sewing a stitching thread along one edge to form a spine 82. Edges 84 of the sheets opposite the spine 82 and opposite side edges 86, 88 are unbound. One of the pages of the passport 80 is referred to as a data page which contains personal information of the intended passport holder including the person's name, an image of the passport holder, a passport number and other data.

FIGS. 5 and 6 illustrate example mechanical arrangements of identification document processing systems that can use one or more of the ribbon supply rolls 50 described herein. FIG. 5 depicts a plastic card personalization machine 90 configured as a desktop printer that processes plastic cards. In other embodiments, the machine 90 can be configured as a desktop printer that processes passports. In FIG. 5, the system 90 is configured with a card input 92 that can hold a plurality of cards waiting to be processed, a card output 94 at the same end of the machine 90 that is configured to hold a plurality of processed cards or is just an output slot, an optional chip programming station 96 that programs an embedded integrated circuit chip in the card, an optional magnetic stripe encoding station 98 that encodes a magnetic stripe on the card, a print station 100, an optional flipper 102 that flips a card 180 degrees, and an optional lamination station 104 that applies a protective laminate to the card. The ribbon supply roll described herein can be used in, for example, the print station 100 and/or in the lamination station 104. Other arrangements of desktop card printers are known and are possible for the machine 90. Further information on the construction and operation of one example of a desktop card printer is disclosed in U.S. Pat. No. 9,904,876 the entire contents of which are incorporated herein by reference.

FIG. 6 depicts a plastic card personalization machine 110 configured as a central issuance machine that simultaneously processes multiple plastic cards in multiple stations or modules with each card progressing through the machine 110 generally in the direction of the arrow A (i.e. a card transport direction). The machine 110 includes a card input 112, an optional chip programming station 114 that simultaneously programs embedded integrated circuit chips in multiple cards, an optional magnetic stripe encoding station 116 that simultaneously encodes magnetic stripes on multiple cards, a print station 118, an optional embossing station 120 for producing embossed characters on the cards and optionally applying a colorant to tips of the embossed characters using a tipping/topping foil, an indenting station 122 for forming indented characters on the cards and optionally applying a colorant into the indented characters using an indent foil, a topcoat station 124 for applying a protective topcoat to the cards, and a card output 126. The ribbon supply roll described herein can be used in, for example, the print station 118, in the embossing station 120, in the indenting station 122, in the topcoat station 124, or in a lamination station. Other arrangements of central issuance machines are known and are possible for the machine 110. Further information on the construction and operation of one example of a central issuance machine is disclosed in U.S. Pat. No. 6,902,107 the entire contents of which are incorporated herein by reference

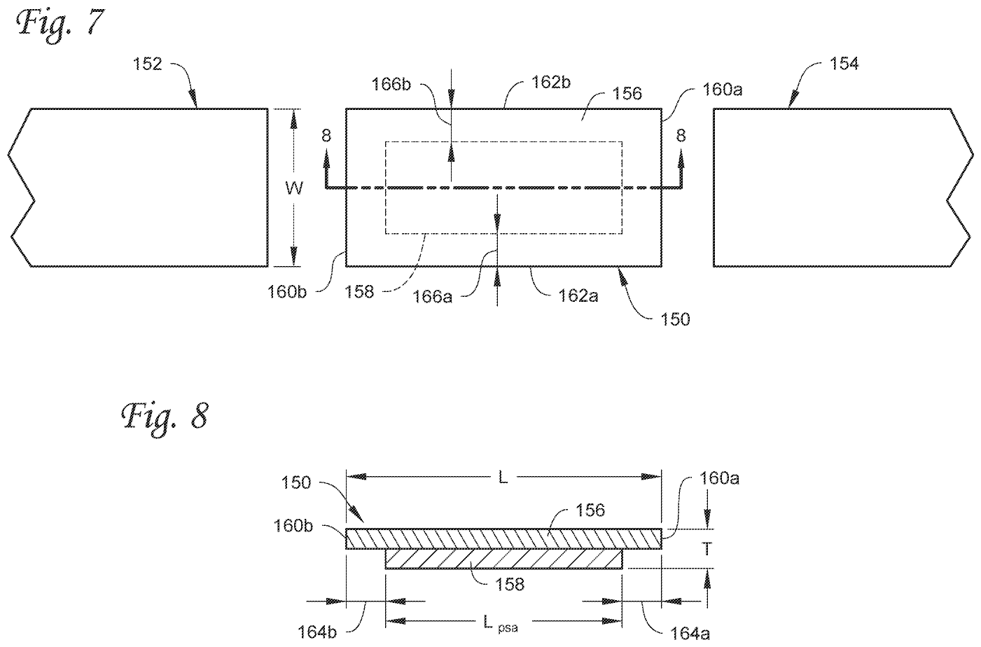

Referring now to FIGS. 7 and 8, the new splice tape 150 described herein is depicted. FIG. 7 depicts the splice tape 150 relative to a first section of ribbon 152 and a second section of ribbon 154 to be interconnected by the splice tape 150. FIG. 8 is a cross-sectional view of the splice tape 150 taken along line 8-8 in FIG. 7. The thicknesses of elements in FIG. 8 are exaggerated for the purposes of explaining the construction of the splice tape 150.

The splice tape 150 includes a backing film 156 and a PSA 158 on the backing film 156. The backing film 156 and PSA 158 can be formed of any materials that are suitable for performing the functions of the backing film 156 and the PSA 158. For example, the backing film 156 can be a polymeric film such as polyester, polyimide, polypropylene, or the like. For example, the backing film 156 may be a 92-gauge polyester film. The PSA 158 can be a high tack PSA, and in one embodiment can have properties, for example adhesive properties and an opacity that is high enough to trigger a photocell, similar to 3M 850 black tape available from 3M Co. of St. Paul, Minnesota. The splice tape has a thickness T which, for example, can be less than or equal to 3M 850 black tape (i.e. less than or equal to about 1.9 mils or 0.05 mm). However, a thicker splice tape can be used. If one or both of the ribbons 152, 154 are transparent to infrared light, the backing film 156 and/or the PSA 158 can be opaque to infrared light. Conversely, if one or both of the ribbons 152, 154 are opaque to infrared light, the backing film 156 and/or the PSA 158 may be transparent to infrared light or opaque to infrared light.

With continued reference to FIGS. 7 and 8, the backing film 156 has a length L defined between opposite end edges 160a, 160b and a width W defined between opposite side edges 162a, 162b. In one embodiment, the length L can be from about 1.90 cm (about 0.75 inch) to about 3.81 cm (about 1.50 inch), or from about 2.54 cm (about 1.00 inch) to about 3.18 cm (about 1.25 inch), or the length L can be about 2.80 cm (about 1.10 inch). The width W can be substantially equal to the width of the sections of ribbon 152, 154. In one embodiment, the width W can be about cm (about 2.28 inch), or about 5.71 cm (about 2.25 inch), or about 2.79 cm (about 1.10 inch). However, many other lengths L and widths W are possible.

The PSA 158 is provided on the backing film 156 in a manner such that when the sections of ribbon 152, 154 are interconnected by the splice tape 150 and wound into a supply roll, the PSA 158 does not flow or extend beyond at least the end edges 160a, 160b of the backing film 156. In an optional embodiment, the PSA 158 is also configured such that it also does not flow or extend beyond the side edges 162a, 162b of the backing film 156. As depicted in FIGS. 7 and 8, the PSA 158 does not cover the entire surface area of the backing film 156. This partial coverage of the surface area of the backing film 156 by the PSA 158 may be referred to as zone-coated PSA or a zone-coated splice tape.

For example, there is a gap 164a (also referred to as an end gap 164a) provided between the PSA 158 and the end edge 160a, and there is a gap 164b (also referred to as an end gap 164b) provided between the PSA 158 and the end edge 160b. In an embodiment, the PSA 158 can have a length Lₚₛₐ which can be, for example, about 2.29 cm to about 2.79 cm (about 0.90 inch to about 1.10 inch), or from about 2.41 cm to about 2.67 cm (about 0.95 inch to about 1.05 inch), or about 2.54 cm (about 1.00 inch). The gaps 164a, 164b may have the same value or they may have different values. In an embodiment, the gaps 164a, 164b may each be at least about 0.0254 cm to about 0.635 cm (about 0.01 inch to about 0.25 inch), or at least about 0.0762 cm to about 0.432 cm (about 0.03 inch to 0.17 inch). In one embodiment, the gaps 164a, 164b may each be about cm (about 0.030 inch). Each one of the gaps 164a, 164b may also be from about 1% to about 5% of the length L of the backing film 156, or from about 2% to about 4% of the length L of the backing film 156, or about 3% to about 3.5% of the length L of the backing film 156. In another embodiment, one or both of the gaps may be up to about 20% of the length L of the backing film 156.

In an optional embodiment, as seen in FIG. 7, there may be a gap 166a (also referred to as a side gap 166a) between the PSA 158 and the side edge 162a, and a gap 166b (also referred to as a side gap 166b) between the PSA 158 and the side edge 162b. As described in further detail below, the gaps 164a, 164b (and optionally the gaps 166a, 166b) are such that the PSA 158 is allowed to flow under pressure when wound into a ribbon supply roll. However, the PSA 158 does not flow beyond the edges 160a, 160b (and optionally the edges 162a, 162b). In another embodiment, without side gaps the PSA 158 extends to the side edges 162a, 162b.

Returning to FIG. 7, the first and second sections of ribbon 152, 154 can be any ribbons used in plastic card or passport personalization machines. For example, the first section of ribbon 152 can be a print ribbon, a retransfer film, a laminate ribbon, a topcoat ribbon, a holographic film, an embossed character tipping/topping foil, an indent foil, a trailer film, or a leader film. The second section of ribbon 154 can be a print ribbon, a retransfer film, a laminate ribbon, a topcoat ribbon, a holographic film, an embossed character tipping/topping foil, an indent foil, a trailer film, or a leader film.

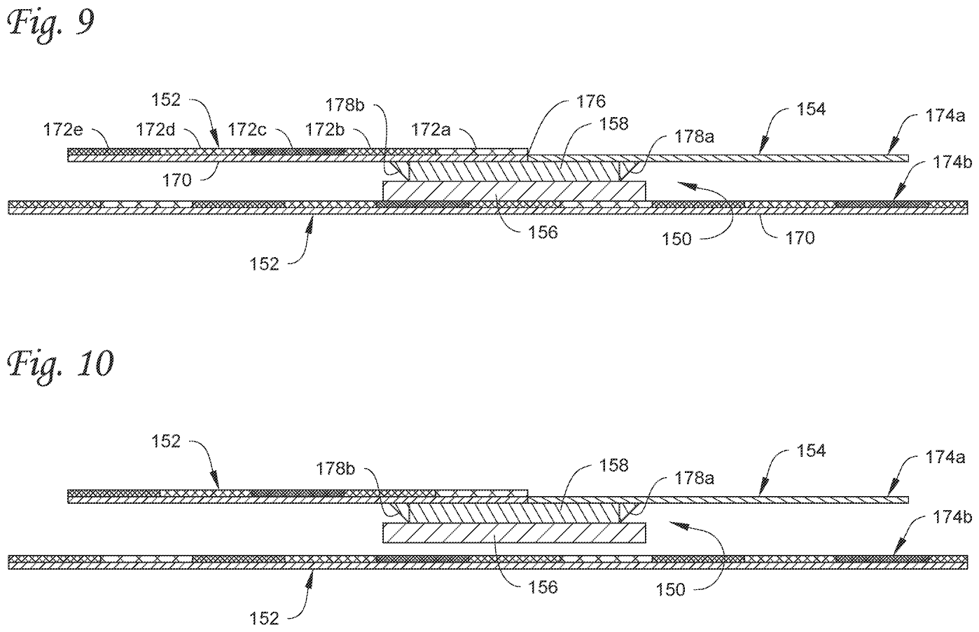

FIGS. 9-10 illustrate an example of the splice tape 150 interconnecting the first section of ribbon 152 and the second section of ribbon 154. In FIGS. 9-10, the relative thicknesses of the splice tape 150 and its components relative to the thicknesses of the ribbon sections 152, 154 are greatly exaggerated in order to better illustrate the concepts. In this example, the ribbon 152 is depicted as being a print ribbon that includes a carrier film 170 and a transferrable material in the form of separate ink/dye panels 172a-d and an optional topcoat material panel 172e disposed on the carrier film 170 for applying coloring and/or a topcoat to a plastic card or a passport. For example, the ribbon 152 may be a YMCKT print ribbon, a YMCK print ribbon, a YMCKT-KT print ribbon, or any other combination of panels known in the art. However, the ribbon 152 may be a monochromatic ribbon that contains a single transferrable color material. The ribbon 154 is depicted as being a trailer film without any transferrable material thereon used to initiate winding of the ribbon 152 onto a core.

FIGS. 9-10 illustrate two consecutive winding layers 174a, 174b of a supply roll formed by the ribbon sections 152, 154 with the winding layer 174b being positioned radially outward of and wound around the winding layer 174a. The winding layer 174a includes the first section of ribbon 152 that is interconnected to the second section of ribbon 154 by the splice tape 150 at the joint 176. The winding layer 174b is a continuation of the first section of ribbon 152 that is wound around the winding layer 174a, with numerous additional winding layers (not illustrated) corresponding to the first section of ribbon 152 wound over the winding layer 174b to form the print ribbon supply roll.

FIG. 9 shows that as a result of the pressure applied to the splice tape 150 by the winding layer 174b and the subsequent winding layers, portions 178a, 178b of the PSA 158 can flow or ooze. However, the flowed portions 178a, 178b do not extend beyond the end edges of the backing film 156. Therefore, none of the PSA 158 adheres to any of the transferable materials 172a-e of the winding layer 174b. Referring to FIG. 10, when it comes time to use that section of the winding layer 174b and that section of the winding layer 174b is unwound from the splice tape 150, no portions of the transferrable materials 172a-e are peeled off the winding layer 174b and no voids are formed.

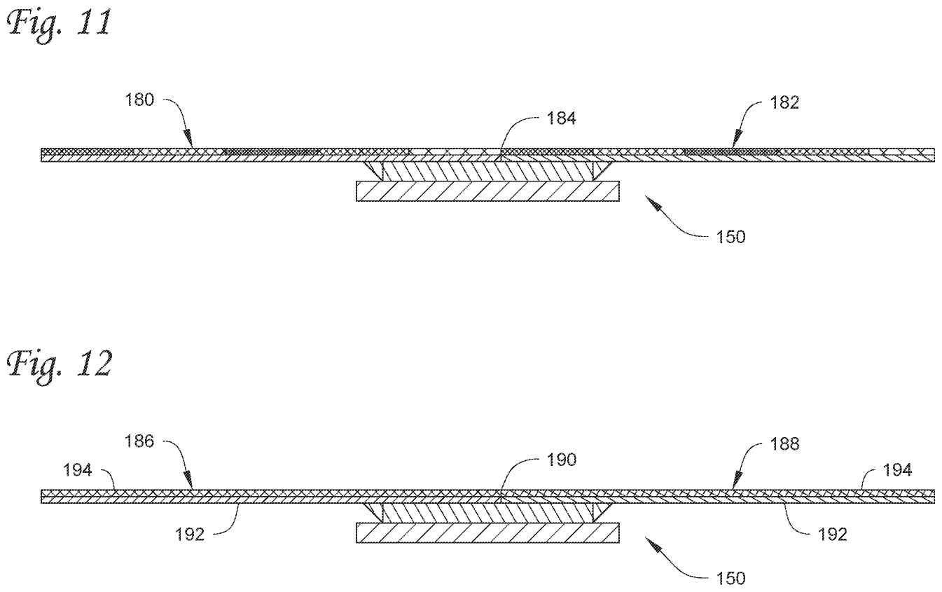

FIG. 11 illustrates another example use of the splice tape 150 interconnecting a first section of ribbon 180 and a second section of ribbon 182 at a joint 184. In this example, both of the ribbon sections 180, 182 are depicted as being print ribbons which can have a construction similar to the ribbon 152 in FIGS. 9-10. In this example, the splice tape 150 is used to interconnect the two print ribbons 180, 182 so that the print ribbon 180 forms a continuation of the print ribbon 182 or vice versa.

FIG. 12 illustrates another example use of the splice tape 150 interconnecting a first section of ribbon 186 and a second section of ribbon 188 at a joint 190. In this example, both of the ribbon sections 186, 188 are depicted as being ribbons that each include a carrier film 192 and a single transferrable material 194. The transferrable material 194 can be an ink or dye colorant, for example of a monochromatic print ribbon, a tipping/topping foil, or an indent foil; or a non-colorant transferrable material, such as a transferrable print receptive layer of a retransfer film, a transferrable laminate of a laminate ribbon, a transferrable protective topcoat of a topcoat ribbon, or a transferrable holographic patch of a holographic film.

Although the figures and description disclose the ribbons as having a single layer of transferrable material, the ribbons described herein can include multiple transferrable layers. For example, in the case of a retransfer film, the retransfer film can include a transferrable print receptive layer and a layer that forms a protective layer that are both simultaneously transferred to a plastic card or passport after printing an image on the print receptive layer.

The examples disclosed in this application are to be considered in all respects as illustrative and not limitative. The scope of the invention is indicated by the appended claims rather than by the foregoing description; and all changes which come within the meaning and range of equivalency of the claims are intended to be embraced therein.

1. A ribbon supply roll for use in a plastic card or passport personalization machine, the ribbon supply roll comprising:
a core;
a ribbon wound on the core, at least a portion of the ribbon includes a carrier film and a transferrable material disposed on the carrier film, wherein the transferrable material is suitable for being transferred from the carrier film to a plastic card or a passport in the plastic card or passport personalization machine;
a splice tape disposed along a length of the ribbon and interconnecting two initially separate sections of the ribbon, the splice tape includes a backing film and a pressure sensitive adhesive on the backing film, and the pressure sensitive adhesive does not extend beyond edges of the backing film.

2. The ribbon supply roll of claim 1, wherein the ribbon comprises a print ribbon, a retransfer film, a laminate ribbon, a topcoat ribbon, a holographic film, an embossed character tipping/topping foil, or an indent foil.

3. The ribbon supply roll of claim 1, wherein the ribbon comprises a multi-color print ribbon or a monochromatic print ribbon.

4. The ribbon supply roll of claim 1, wherein the transferrable material comprises thermally transferrable material.

5. The ribbon supply roll of claim 4, wherein the thermally transferrable material comprises ink, dye, a protective topcoat material, or a retransfer material.

6. The ribbon supply roll of claim 1, wherein one section of the two initially separate sections does not include the transferrable material.

7. The ribbon supply roll of claim 6, wherein the one section is a trailer ribbon or a leader ribbon.

8. The ribbon supply roll of claim 1, wherein the transferrable material is disposed on a first side of the carrier film, and the splice tape is disposed on a second side of the carrier film.

9. A method of forming a ribbon supply roll of a plastic card or passport personalization machine, the method comprising:
interconnecting a first section of ribbon and a second section of ribbon using splice tape, at least one of the first section of ribbon and the second section of ribbon includes a carrier film and a transferrable material disposed on the carrier film, wherein the transferrable material is suitable for being transferred from the carrier film to a plastic card or a passport in the plastic card or passport personalization machine, and the splice tape includes a backing film and a pressure sensitive adhesive on the backing film, and there are gaps between the pressure sensitive adhesive and edges of the backing film;
winding the interconnected first section of ribbon and second section of ribbon onto a core.

10. The method of claim 9, wherein the ribbon supply roll comprises a print ribbon, a retransfer film, a laminate ribbon, a topcoat ribbon, a holographic film, an embossed character tipping/topping foil, or an indent foil.

11. The method of claim 9, wherein the ribbon supply roll comprises a multi-color print ribbon or a monochromatic print ribbon.

12. The method of claim 9, wherein the transferrable material comprises thermally transferrable material.

13. The method of claim 12, wherein the thermally transferrable material comprises ink, dye, a protective topcoat material, or a retransfer material.

14. The method of claim 9, wherein one of the first section of ribbon and the second section of ribbon does not include the transferrable material.

15. The method of claim 9, each of the first section of ribbon and the second section of ribbon includes the carrier film and a transferrable material disposed on the carrier film.

16. The method of claim 14, wherein the one of the first section of ribbon and the second section of ribbon does that does not include the transferrable material is a trailer ribbon or a leader ribbon.

17. The method of claim 9, wherein the transferrable material is disposed on a first side of the carrier film, and the splice tape is disposed on a second side of the carrier film.

18. The method of claim 9, where the gaps are located between end edges of the pressure sensitive adhesive and end edges of the backing film.

19. An identification document processing system, comprising:
a plastic card or passport personalization machine; and
at least one of the ribbon supply rolls of claim 1 mounted in the plastic card or passport personalization machine.

20. The identification document processing system of claim 19, wherein the plastic card or passport personalization machine is a desktop machine or a central issuance machine.
